(19) United States
(12) Patent Application Publication
(10) Pub. No.: US 2015/0215157 A1
(43) Pub. Date: Jul. 30, 2015

(54) Method for Operating a Redundant Communication Network

(71) Applicant: Robert Bosch GmbH, Stuttgart (DE)

(72) Inventors: Rigobert Kynast, Lohr-Wombach (DE); Christian Kaufmann, Bischbrunn-Oberndorf (DE); Gunther May, Karlstadt (DE)

(21) Appl. No.: 14/602,317

(22) Filed: Jan. 22, 2015

(30) Foreign Application Priority Data
Jan. 27, 2014 (DE) 10 2014 201 373.9

(51) Int. Cl. H04L 12/24; H04L 1/22

(52) U.S. Cl. CPC H04L 41/0659; H04L 1/22

(57) ABSTRACT

A method for operating a redundant communication network with at least two main participants and at least two secondary participants. The secondary participants communicate with one another using a data transmission device directly using the data transmission device and/or indirectly using at least one main participant and the data transmission device. The main participants exchange the data which are to be exchanged between the secondary participants between their data transmission device connections and communicate with one another directly in a temporally synchronized manner using at least one main participant data transmission device. During operation, at least one of the main participants maintains a communication between the secondary participants and/or between the main participant and the secondary participants. In the event of a fault of one of the main participants, the respective other main participant maintains a communication between the secondary participants and/or between the main participant and the secondary participants.

This application claims priority under 35 U.S.C. §119 to application no. DE 10 2014 201 373.9, filed on Jan. 27, 2014 in Germany, the disclosure of which is incorporated herein by reference in its entirety.

### BACKGROUND

The present disclosure relates to a method for operating a redundant communication network and also a communication network and a drive system.

In particular, the communication network described here comprises at least two main participants and at least two secondary participants, wherein the secondary participants communicate with one another by means of a data transmission device, wherein the secondary participants communicate with one another directly by means of the data transmission device and/or communicate with one another indirectly by means of at least one main participant and the data transmission device, in that the main participants exchange the data which are to be exchanged between the secondary participants between their data transmission device connections.

DE 198 03 686 A1 relates to a method for the communication of stations with equal access authorization of a ring-shaped, serial optical waveguide bus, EP 1 585 266 A2 shows a communication system with a main participant and secondary participants. The behavior of the communication systems in the event of a fault is not described in the aforementioned documents.

Ring-shaped communication systems with a redundancy function are known from the prior art, comprising a main participant (“Master”) and secondary participants (“Slaves”). Communication systems of this type are disclosed, for example, in WO 03/073704 A1 or U.S. 2004/223503 A1. An example of a communication system with a redundancy function is defined by the SERCOS-III standard, which is described in detail, for example, in the publication “SERCOS-III (Dritte Generation SERCOS interface)” [“SERCOS-III (Third-generation SERCOS interface)”], version 1.3.4, April 2004 of the association SERCOS interface e.V., or the publication “Innovation durch Kombination” [“Innovation through combination”] PRAXIS PROFILINE—SERCOS INTERFACE, May 31, 2004 (2004-05-31), pages 26-28.

The German patent application with the file reference DE 10 2004 041 093 describes a ring-shaped communication system of this type in FIG. 1a, which could represent, for example, a control and drive system for shaftless production machines. Systems of this type use a so-called opposed double ring for communication. In the event of redundancy (in the event of a fault), the double ring breaks up into two line topologies. A communication between secondary stations unaffected by the fault then takes place exclusively through the copying of all data transmitted by secondary participants via the main station. This substantially increases the utilization of the main station and causes propagation delays between immediately adjacent secondary participants.

### SUMMARY

The object of the disclosure is to ensure a data transmission even in the event of a fault and to avoid propagation delays between secondary participants as far as possible.

In order to ensure a data transmission even in the event of a fault and avoid propagation delays between secondary participants as far as possible, the method proposed here makes use, inter alia, of the idea that the two main participants communicate with one another directly, in particular in a temporally synchronized manner, by means of at least one main participant data transmission device, wherein, during operation, at least one of the main participants maintains a communication between the secondary participants and/or between the main participant and the secondary participants, and wherein, in the event of a fault of one of the main participants, the respective other main participant maintains a communication between the secondary participants and/or between the main participant and the secondary participants.

The data transmission device and/or the main participant data transmission device could, for example, be implemented by means of a line-connected or radio-connected data transmission which permits a two-way communication. The data transmission device connections of the main participant are the interfaces between the main participant and the data transmission device. Since this entails a ring-shaped, redundant system, each participant (secondary participant and main participant) comprises four connections for the data transmission device (each case two inputs and two outputs). The disclosure provides a redundant and failsafe system, since the secondary participants can communicate directly with one another independently from the main participant, as a result of which they relieve the load on the latter Immediately adjacent secondary participants thus communicate with one another on the shortest path, which reduces the propagation time of the data. In addition, in the event of a functional fault of the data transmission device, the secondary participants are nevertheless still able to communicate by means of the main participant.

A method is thus proposed which, in a particularly simple and economical manner, through the introduction of two data networks, i.e. a data transmission device for the communication between the secondary participants and a main participant data transmission device for direct data transmission between main participants, if one of the main participants fails, nevertheless still enables the entire communication network to remain operable with no propagation delay by means of the respective other, still fully functional, main participant. The other main participant is therefore also to be understood as a “buffer participant” which is integrated into the communication system as a reserve.

According to at least one embodiment, the communication network described here comprises at least two main participants and at least two secondary participants, wherein the secondary participants communicate with one another by means of a data transmission device, wherein the secondary participants communicate with one another directly by means of the data transmission device and/or communicate with one another indirectly by means of at least one main participant and the data transmission device, in that the main participants exchange the data which are to be exchanged between the secondary participants between their data transmission device connections. The two main participants communicate with one another directly, in particular in a temporally synchronized manner, by means of at least one main participant data transmission device, wherein, during operation, at least one of the main participants maintains a communication between the secondary participants and/or between the main participant and the secondary participants, and wherein, in the event of a fault of one of the main participants, the respective other main participant maintains a communication between the secondary participants and/or between the main participant and the secondary participants.

According to at least one embodiment, a main participant communication is initially set up in a commissioning phase of the communication network, from a start of the commissioning phase, between the two main participants by at least one of the two main participants, preferably only via the main participant data transmission device. In particular, the main participant data transmission device can essentially be designed in the form of a SERCOS-III communication network. The commissioning phase differs from a normal operation in particular also in that all participants are at least not yet powered up in a desired target operating mode. If one of the two main participants then fails due to a fault, the entire communication network can still be further operated without propagation delays by the respective other, still functional, main participant.

According to at least one embodiment, both main participants are already activated and temporally synchronized with one another during the commissioning phase. In an embodiment of this type, both main participants are therefore already active from the start in such a way that they send, for example, communication telegrams (e.g. SERCOS-III telegrams) to the secondary participants and/or the respective other main participant. In other words, in an embodiment of this type, when the communication system is started up, the main participant communication can initially be carried out separately by a main participant (the actual “Master”) separately from the data transmission device via the separate main participant data transmission device. One of the two main participants assumes the actual “Master role” for the main participant communication and initializes the main participant communication, for example in the manner of a “SERCOS-III network”. Both main participants can thus be temporally synchronized with one another. The entire “Master-Slave network” can then be started up, wherein both main participants' nodes are active from the start.

According to at least one embodiment, the data transmission device and the main participant data transmission device are designed as a common main communication network (SERCOS-III network). In this embodiment, all “nodes”, of the two main participants and also of the secondary participants can be disposed in this common main communication network.

According to at least one embodiment, from a start of a commissioning phase of the communication network, only one of the two main participants of the communication network is activated for the commissioning and the other main participant operates passively not only during the commissioning phase but also during a subsequent normal operation and is temporally synchronized with the main participant. In other words, during a power-up and also during the subsequent normal operation, the second main participant is initially passive, but is synchronized with the communication network and forwards, for example, received packets, after it has interpreted them if necessary. Only if one of the two main participants fails due to a fault and this is detected by the second main participant on the basis of defined monitoring criteria, for example an absence of communication telegrams, the latter assumes the actual main participant role in the main participant-secondary participant communication, so that the communication network of the original main participant can continue to be operated.

According to at least one embodiment, the other main participant is activated and/or activates itself only in the event of a fault of the active main participant. In other words, as already explained above, the respective inactive main participant can be operated “as a reserve”.

According to at least one embodiment, a disruption caused by the fault event is communicated by means of the data transmission device and/or the main participant data transmission device to the still functioning main participant and the other main participant coordinates the communication on the basis of the localized disruption.

In addition, a communication network to carry out a method as described in one or more of the aforementioned embodiments is disclosed. This means that the features disclosed for the communication network described here are also disclosed for the communication network described here and vice versa.

According to at least one embodiment, the communication network is based on Ethernet technology or on optical waveguide technology, wherein the data transmission is based, in particular, on a fieldbus standard. Ethernet technology enables a simple handling of the connection lines, since the latter are normally based on copper lines. Ethernet is tried and tested, less costly and less prone to faults. Optical waveguide technology is insensitive to electromagnetic interference and increases data security. The implementation of the communication network in a fieldbus network (Profibus, SERCOS, CANopen, etc.) provides access to automation technology. If a real-time-enabled communication is used, further advantageous fields of application are opened up, particularly in the processing of time-critical data.

In addition, a drive system is disclosed, in particular for automation purposes, with a communication network described here. This means that the features disclosed for the communication network described here are also disclosed for the drive system described here and vice versa.

According to at least one embodiment, said drive system comprises an electrical controller and/or electrical drive controllers as main participants and electrical controllers and/or electrical drive controllers as secondary participants. The concept according to the disclosure increases the availability of the machines of which the automation system is comprised.

### BRIEF DESCRIPTION OF THE DRAWINGS

Exemplary embodiments of the disclosure are presented in the drawings and are explained in more detail in the description below:

In the drawings:

FIG. 1 shows a redundant communication network according to the disclosure.

### DETAILED DESCRIPTION

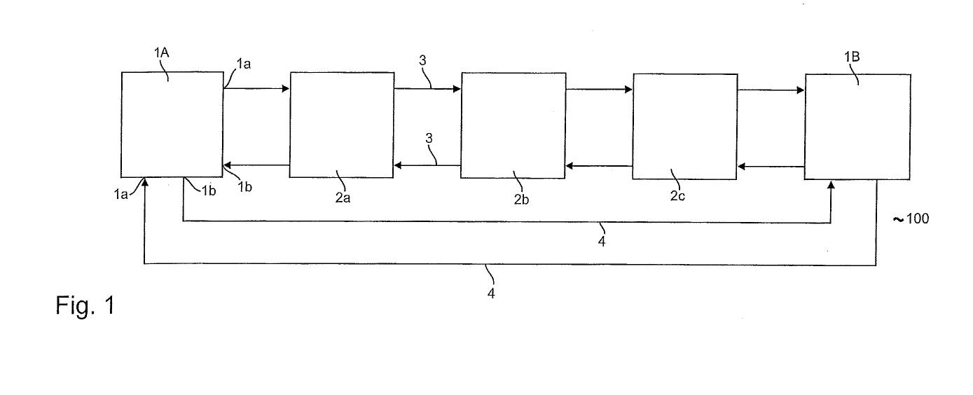

The communication network 100 shown in FIG. 1 comprises two main participants 1A, 1B, in each case with a data processing device 1c and in each case two data transmission device connections 1a and 1b and secondary participants 2a, b, c, which are directly interconnected by means of a two-way data transmission device 3 (connection line). The two-way data transmission device 3 enables a direct and two-way data exchange between the individual secondary participants 2a, b, c and the main participant 1A and/or 1B. In addition to the two-way connection 3 in the form of an opposed ring, redundancy can be provided in that secondary participants 2a, b, c can also communicate with one another by means of the main participant 1. The secondary participant 2b, for example, is thus able to communicate either directly with the secondary participant 2c by means of the two-way connection 3, or indirectly by means of the main participant 1.

In addition, the two main participants 1A, 1B communicate with one another directly, at least in a temporally synchronized manner, by means of at least one separate main participant data transmission device 4, wherein, during operation, at least one of the main participants 1A, 1B maintains a communication between the secondary participants 2a, b, c and/or between the main participant 1A, 1B and the secondary participants 2a, b, c, and wherein, in the event of a fault of one of the main participants 1A, 1B, the respective other main participant 1A, 1B maintains a communication between the secondary participants 2a, b, c and/or between the main participant 1A, 1B and the secondary participants 2a, b, c.

In particular, a main participant communication is initially set up between the two main participants 1A, 1B during a commissioning phase of the communication network 100, from a start of the commissioning phase, by at least one of the two main participants 1A, 1B, preferably only via the main participant data transmission device 4, wherein both main participants 1A, 1B are already activated and temporally synchronized with one another during the commissioning phase.

In an alternative mode of operation, only one of the two main participants 1A, 1B is activated for the commissioning of the communication network 100 only from a start of a commissioning phase of the communication network, and the other main participant operates passively both during the commissioning phase and during a subsequent normal operation and is temporally synchronized with the main participant. The other main participant is activated and/or activates itself only in the event of a fault of the active main participant.

A communication network 100 is thus proposed which, in a particularly simple and economical manner, through the introduction of two data networks 3, 4, i.e. a data transmission device 3 for the communication between the secondary participants 2a, 2b, 2c and a main participant data transmission device 4 for the direct data transmission between main participants 1A, 1B, if one of the main participants 1A, 1B fails, nevertheless still enables the entire communication network 100 to remain operable with no propagation delay by means of the respective other, still fully functional, main participant. The other main participant is therefore also to be understood as a “buffer participant” which is integrated into the communication system as a reserve.

What is claimed is:

1. A method for operating a redundant communication network having at least two main participants and at least two secondary participants, the method comprising:
establishing, using a first data transmission device, a communication between the at least two secondary participants, the communication between the at least two secondary participants being at least one of (i) direct, using the first data transmission device, and (ii) indirect, using at least one of the at least two main participants and the first data transmission device;
exchanging data between the at least two secondary participants using data transmission device connections of the at least two main participants;
establishing, using a second data transmission device, a communication between the at least two main participants, the communication between the at least two main participants being direct and temporally synchronized;
maintaining, during operation, using least one of the at least two main participants, at least one of (i) a communication between the at least two secondary participants and (ii) a communication between the one of the at least two main participants and the at least two secondary participants; and
maintaining, in the event of a fault of one of the at least two main participants, using a respective other of the at least two main participants, at least one of (i) a communication between the at least two secondary participants and (ii) a communication between the one of the at least two main participants and the at least two secondary participants.

2. The method according to claim 1, further comprising:
establishing, at a start of a commissioning phase, the communication between the at least two main participants.

3. The method according to claim 2, further comprising:
activating both of the at least two main participants with one another before the start of the commissioning phase; and
temporally synconronizing both of the at least two main participants with one another before the start of the commissioning phase.

4. The method according to claim 1, wherein the data first transmission device and the second data transmission device are configured as a common main communication network.

5. The method according to claim 1, further comprising:
activating a first of the at least two main participants at a start of a commissioning phase;
operating a second of the at least two main participants passively during the commissioning phase and during a subsequent normal operation; and
synchronizing the second of the at least two main participants with the first of the at least two main participants.

6. The method according to claim 5, further comprising:
activating the second of the at least two main participants in the event of a fault of the first of the at least two main participants.

7. The method according to claim 6, further comprising:
communicating, using at least one of the first data transmission device and the second data transmission device, a disruption caused by the fault to the second of the at least two main participants, the communicating of the disruption being coordinated by the second of the at least two main participants based on the disruption.

8. A communication network comprising:
at least two secondary participants;
at least two main participants having data transmission device connections configured to exchange data between the at least two secondary participants, the at least two main participants being configured to:
maintain, during operation, using least one of the at least two main participants, at least one of (i) a communication between the at least two secondary participants and (ii) a communication between the one of the at least two main participants and the at least two secondary participants; and
maintain, in the event of a fault of one of the at least two main participants, using a respective other of the at least two main participants, at least one of (i) a communication between the at least two secondary participants and (ii) a communication between the one of the at least two main participants and the at least two secondary participants;
a first data transmission device configured to establish a communication between the at least two secondary participants, the communication between the at least two secondary participants being at least one of (i) direct, using the first data transmission device, and (ii) indirect, using at least one of the at least two main participants and the first data transmission device; and
a second data transmission device configured to establish a communication between the at least two main participants, the communication between the at least two main participants being direct and temporally synchronized,
wherein the communication network is at least one of based on Ethernet technology and based on optical waveguide technology and data transmission is based on a fieldbus standard.

9. The communication network of claim 8, wherein:
the at least two main participants are at least one of electrical controllers of a drive system and electrical drive controllers of a drive system; and
the at least two secondary participants are at least one of electrical controllers of a drive system and electrical drive controllers of a drive system.

10. The method according to claim 2, further comprising:
establishing the communication between the at least two main participants using only the second data transmission device.

11. The method according to claim 4, wherein the data first transmission device and the second data transmission device are configured as a SERCOS-III network.
